(19) United States
(12) Patent Application Publication
(10) Pub. No.: US 2026/0307254 A1
(43) Pub. Date: Oct. 8, 2026

(54) REAL-TIME COLLISION AND OVERSPEED DETECTION SYSTEM FOR COLLABORATIVE ROBOT USING JOINT-WISE CURRENT-BASED TORQUE CONTROL

(71) Applicant: BRILS Co., Ltd., Incheon (KR)

(72) Inventor: Jin JEON, Incheon (KR)

(21) Appl. No.: 19/638,200

(22) Filed: Apr. 3, 2026

(30) Foreign Application Priority Data
Apr. 4, 2025 (KR) 10-2025-0044172

(51) Int. Cl. B25J 9/16; B25J 13/08

(52) U.S. Cl. CPC B25J 9/1674; B25J 9/1607; B25J 9/1633; B25J 9/1643; B25J 9/1651; B25J 13/085; B25J 13/088

(57) ABSTRACT

An embodiment relates to a real-time collision and overspeed detection system for a collaborative robot. More specifically, the real-time collision and overspeed detection system for a collaborative robot according to one embodiment may include: a collaborative robot including a plurality of joint portions, each provided with a motor; a current sensor configured to acquire current data supplied to the motor; an encoder configured to acquire rotation data of the plurality of joint portions; and a control unit configured to detect an abnormal state of the collaborative robot based on the current data and the rotation data.

### CROSS REFERENCE TO RELATED APPLICATION

The present application claims priority to Korean Patent Application No. 10-2025-0044172, filed Apr. 4, 2025, the entire contents of which are incorporated here for all purposes by this reference.

### TECHNICAL FIELD

The present disclosure relates to a system for real-time detection of collision and overspeed of a collaborative robot, and more particularly, to a system configured to promptly detect collision, overload, overspeed, and singularity by real-time monitoring of current and torque data of robot joints using joint-wise current-based torque control.

### BACKGROUND

Conventional collaborative robot systems have attempted to detect collision and overspeed by using external sensors or camera-based image analysis technologies. However, such methods may involve high installation and maintenance costs, and may be vulnerable to interference between sensors or changes in external environments, thereby making precise real-time detection difficult.

In addition, conventional technologies may have limitations in that embedded monitoring systems capable of reflecting, in real time, actual operation and load conditions of robot joints are insufficient, and thus safety issues caused by collision, overload, or overspeed may be difficult to resolve immediately.

To address such problems, there is an increasing need for a technology capable of more simply and promptly detecting collision, overspeed, overload, and singularity situations based on internal data of a robot.

### PRIOR ART DOCUMENT

### Patent Document

Patent Document: Korean Patent No. 10-2784903.

### SUMMARY

An object of the present disclosure is to provide an apparatus and method capable of promptly detecting a collision of a collaborative robot, thereby preventing, in real time, safety problems that may occur due to an unexpected external impact or contact with an obstacle.

Another object of the present disclosure is to provide an apparatus and method capable of accurately determining a collision state and an overload state by acquiring, in real time, current data supplied to a motor and analyzing a difference between the current data and an expected current value during a normal operation.

Another object of the present disclosure is to provide an apparatus and method capable of promptly detecting an overspeed state by acquiring rotation data of a joint from an encoder and comparing an actual speed of the robot with a target speed, thereby safely controlling an operation of the robot.

Another object of the present disclosure is to provide an apparatus and method capable of preventing an unstable operation in a singularity state in advance by calculating a minimum singular value of a Jacobian matrix using joint angle data of the robot and evaluating, in real time, whether the robot is close to a singularity.

Another object of the present disclosure is to provide an apparatus and method capable of realizing safe and efficient robot control by including a control unit configured to integrally analyze current data and rotation data acquired from various sensors, thereby promptly detecting a collision state, an overload state, an overspeed state, and a singularity state of a collaborative robot.

Objects of the present disclosure are not limited to those described above, and other objects not described herein will be clearly understood by those skilled in the art from the following description.

In order to achieve the above-described objects, according to one aspect of the present disclosure, there is provided a real-time collision and overspeed detection system for a collaborative robot, including: a collaborative robot including a plurality of joint portions, each provided with a motor; a current sensor configured to acquire current data supplied to the motor; an encoder configured to acquire rotation data of the plurality of joint portions; and a control unit configured to detect an abnormal state of the collaborative robot based on the current data and the rotation data.

Moreover, the control unit may calculate a current sample value based on the current data, compare the current sample value with a collision threshold value, and determine that the collaborative robot is in a collision state when the current sample value exceeds the collision threshold value.

Moreover, the control unit may calculate the current sample value for determining collision according to Equation 1.

$${C}_{k} = \frac{1}{H} {\sum }_{j = k - H + 1}^{k} \vert {I}_{j} - {I}_{{exp}_{j}} \vert \qquad [ Equation 1 ]$$

wherein k is a natural number, Ij is a current measured at a current time point, Iexpj is an expected current at the current time point, H is the number of sampling intervals, and Ck is the current sample value.

Moreover, the control unit may calculate a current interval value based on the current data, compare the current interval value with an overload threshold value, and determine that the collaborative robot is in an overload state when the current interval value exceeds the overload threshold value.

Moreover, the control unit may calculate the current interval value according to Equation 2.

$${O}_{k} = \frac{1}{L} {\sum }_{j = k - L + 1}^{k} {I}_{j} \qquad [ Equation 2 ]$$

wherein k is a natural number, Ij is a current measured at a current time point, L is a preset measurement interval, and Ok is the current interval value.

Moreover, the control unit may calculate a speed value of the plurality of joint portions based on the rotation data, compare the speed value with an overspeed threshold value, and determine that the collaborative robot is in an overspeed state when the speed value exceeds the overspeed threshold value.

Moreover, the control unit may acquire a singularity index value of the plurality of joint portions based on an angle value of the plurality of joint portions included in the rotation data, compare the singularity index value with a singularity threshold value, and determine that the collaborative robot is in a singularity state when the singularity index value exceeds the singularity threshold value.

Moreover, the control unit may analyze the angle value, calculate a Jacobian matrix at a current time point, extract a minimum singular value from the Jacobian matrix, and calculate the singularity index value according to Equation 3.

$$Mk = \frac{1}{{SMin}_{k}} \qquad [ Equation 3 ]$$

wherein Mk is the singularity index value, and Smink is the minimum singular value.

Moreover, when an abnormal state of the collaborative robot is detected, the control unit may stop an operation of the collaborative robot.

Furthermore, a computer-readable recording medium storing a computer program for implementing the present disclosure may be further provided.

### BRIEF DESCRIPTION OF THE DRAWINGS

FIG. 1 is a block diagram illustrating a detailed configuration of a real-time collision and overspeed detection system for a collaborative robot according to an embodiment of the present disclosure.

FIG. 2 is an exemplary view illustrating a collaborative robot according to an embodiment of the present disclosure.

FIG. 3 is a flowchart illustrating a real-time collision and overspeed detection method for a collaborative robot according to an embodiment of the present disclosure.

FIG. 4 is a flowchart illustrating a method of determining a collision state of a collaborative robot according to an embodiment of the present disclosure.

FIG. 5 is a flowchart illustrating a method of determining an overload state of a collaborative robot according to an embodiment of the present disclosure.

FIG. 6 is a flowchart illustrating a method of determining an overspeed state of a collaborative robot according to an embodiment of the present disclosure.

FIG. 7 is a flowchart illustrating a method of determining a singularity state of a collaborative robot according to an embodiment of the present disclosure.

### DETAILED DESCRIPTION

Throughout the present disclosure, the same reference numerals denote the same components. The present disclosure does not describe all elements of the embodiments, and general contents in the technical field to which the present disclosure pertains or overlapping contents among the embodiments are omitted. The terms “unit, module, member, and block” used in the specification may be implemented as software or hardware, and according to embodiments, a plurality of “units, modules, members, and blocks” may be implemented as one component, or one “unit, module, member, or block” may include a plurality of components.

Throughout the specification, when a portion is described as being “connected” to another portion, this includes not only a case where the portion is directly connected, but also a case where the portion is indirectly connected, and the indirect connection includes connection through a wireless communication network.

In addition, when a portion is described as “including” a certain component, this does not exclude other components unless specifically stated otherwise, and means that other components may be further included.

Throughout the specification, when a member is described as being positioned “on” another member, this includes not only a case where the member is in contact with another member, but also a case where another member exists between the two members.

Terms such as first and second are used to distinguish one component from another component, and the components are not limited by the above terms.

A singular expression includes a plural expression unless the context clearly indicates otherwise.

In each step, identification symbols are used for convenience of description, and the identification symbols do not describe an order of the steps, and the steps may be performed in an order different from the stated order unless the context clearly indicates a specific order.

Hereinafter, operation principles and embodiments of the present disclosure will be described with reference to the accompanying drawings.

In the present specification, a “device according to the present disclosure” includes all types of devices capable of performing arithmetic processing and providing a result to a user. For example, the device according to the present disclosure may include a computer, a server device, and a portable terminal, or may be any one of these forms.

Here, the computer may include, for example, a notebook, a desktop, a laptop, a tablet PC, and a slate PC equipped with a web browser WEB Browser.

The server device is a server that processes information by communicating with an external device, and may include an application server, a computing server, a database server, a file server, a game server, a mail server, a proxy server, and a web server.

The portable terminal is, for example, a wireless communication device that ensures portability and mobility, and may include all types of handheld-based wireless communication devices such as Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband (WiBro) Internet terminal, and a smart phone Smart Phone, and may also include wearable devices such as a watch, a ring, a bracelet, an anklet, a necklace, glasses, contact lenses, or a head-mounted-device (HMD).

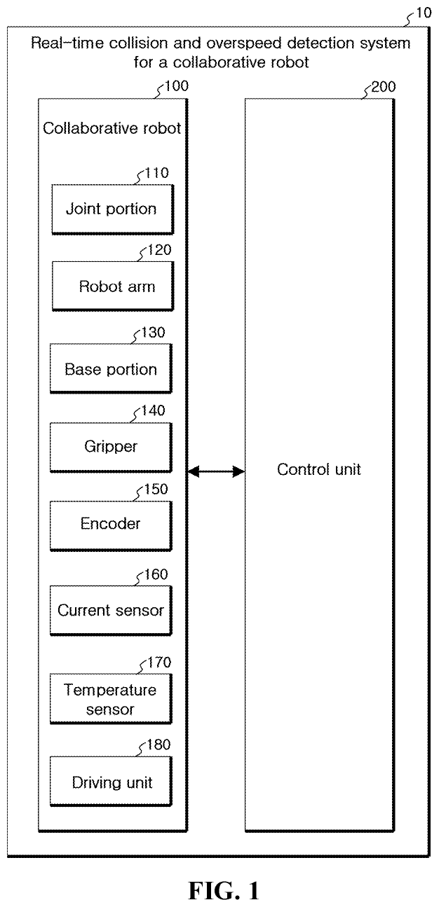

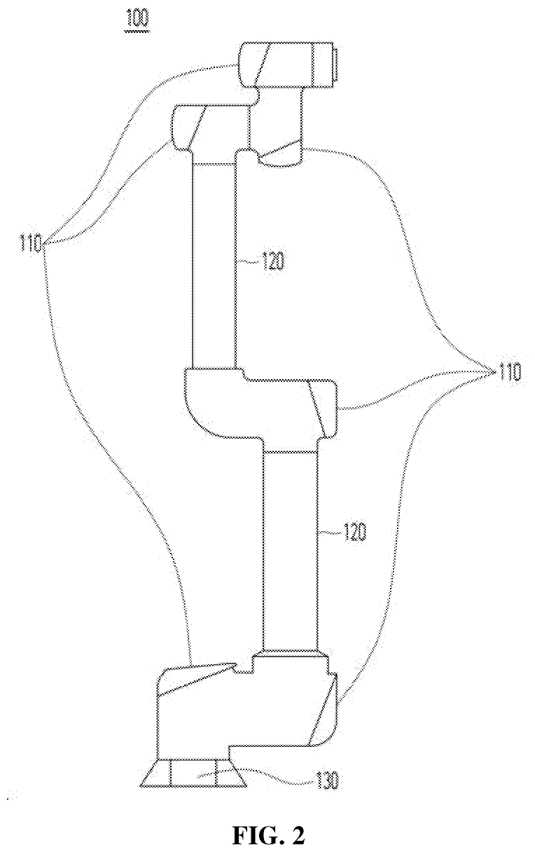

FIG. 1 is a block diagram illustrating a detailed configuration of a real-time collision and overspeed detection system for a collaborative robot according to an embodiment of the present disclosure. FIG. 2 is an exemplary view illustrating a collaborative robot according to an embodiment of the present disclosure.

In one embodiment, the collaborative robot 100 may include a plurality of joint portions 110, a robot arm 120, a base portion 130, a gripper 140, an encoder 150, a current sensor 160, a temperature sensor 170, and a drive unit 180, and each of these components may operate while being interconnected with the control unit 200.

In one embodiment, the collaborative robot 100 may be designed to collaborate with a human in various working environments, such as an industrial site, a research environment, and a service field. In particular, the plurality of joint portions 110 may each have an independent rotational axis, and a motor may be provided in each joint portion 110. The motor may be implemented as, for example, a servo motor, a brushless DC motor, or a stepper motor, and may precisely control a rotation angle of the joint portion 110. Since the joint portions 110 may be formed in a multi-joint structure, the collaborative robot 100 may secure multiple degrees of freedom and move in various directions. For example, some of the joint portions 110 may form horizontal rotational axes, and others may form vertical rotational axes, thereby enabling flexible operation of the robot arm 120.

In one embodiment, the robot arm 120 is a structure connecting the plurality of joint portions 110 to one another, and may generally include a tube made of metal or an alloy frame. The robot arm 120 may route wires or cables therein to supply power required for motors of the joint portions 110 or to transmit, to the control unit 200, signals acquired from the encoder 150, the current sensor 160, the temperature sensor 170, and the like. Since the robot arm 120 is required to satisfy both light weight and rigidity, an aluminum alloy material or a carbon fiber material may be used therefor, and durability may be maintained against an external impact or vibration in a working environment.

In one embodiment, the base portion 130 is a lowermost structure supporting the collaborative robot 100, and may be installed on a fixed floor or a workbench. The base portion 130 may have sufficient weight and fixing force to stably support movement of the joint portions 110 and the robot arm 120 occurring while the collaborative robot 100 operates. In addition, the base portion 130 may manage power and control signals required for overall operation of the robot by accommodating a power supply device and various electronic circuits therein. In addition to fixing the collaborative robot 100 at a specific position for operation, the base portion 130 may also be provided with casters to allow movement when necessary, or may provide an interface for coupling with other equipment.

In one embodiment, the gripper 140 may include a device capable of gripping or manipulating an object having various forms as an end effector of the collaborative robot 100. For example, the form of the gripper 140 may vary according to a work target, such as a two-finger gripper, a three-finger gripper, or a vacuum suction gripper. The gripper 140 may move to a desired position together with rotational operation of the joint portions 110, and may pick up or place an object by performing detailed operations such as opening, closing, or rotating according to a command of the control unit 200. The gripper 140 may additionally include a sensor and may have a function of detecting whether an object is gripped or a weight of the object.

In one embodiment, the encoder 150 is a sensor configured to acquire rotation data of each joint portion 110, and may be implemented in an optical manner, a magnetic manner, or another manner. The encoder 150 may be connected to each joint portion 110 and may transmit, to the control unit 200, a pulse or code generated whenever the joint portion 110 rotates. Through this, the control unit 200 may accurately calculate a current angle, a rotational speed, an acceleration, and the like of the joint portion 110, and may estimate a position of the end effector of the robot arm 120 through an inverse kinematics algorithm or the like when necessary. The rotation data acquired from the encoder 150 may serve as important grounds for determining an abnormal state, such as collision, overspeed, overload, or singularity, which is a core of the present disclosure.

In one embodiment, the current sensor 160 is a sensor capable of acquiring, in real time, current data supplied to the motor, and may be attached to a motor driver circuit of each joint portion 110 or to a separate sensing unit. The current sensor 160 may be implemented in various manners, such as a shunt resistor or a Hall sensor, and may transmit, to the control unit 200, a current value required by the motor. Since a current value measured by the current sensor 160 is directly related to motor torque, when the robot receives an unexpected load or a collision occurs, the current value may instantaneously increase sharply. In the present disclosure, by analyzing such current fluctuation data, a collision state or an overload state may be promptly detected, and safe operation of the robot may be ensured by monitoring with a short cycle of 5 ms or less.

In one embodiment, the temperature sensor 170 is a sensor capable of measuring temperatures of components liable to generate heat, such as the motor or the drive unit 180, and may prevent overheating by monitoring a heat generation state during long-term operation of the collaborative robot 100. For example, the temperature sensor 170 may be attached inside a motor housing or installed adjacent to the drive unit 180, and may transmit, to the control unit 200, a surface temperature or an internal temperature of a corresponding component. When a temperature value transmitted from the temperature sensor 170 exceeds an allowable range, the control unit 200 may temporarily stop operation of the motor or operate a cooling fan, thereby preventing damage to the robot and a safety accident.

In one embodiment, the drive unit 180 may refer to a component in which mechanical elements for actually rotating the joint portion 110, such as a motor, a reducer, a bearing, and a gear, are integrated. The drive unit 180 may operate while being directly connected to a rotational shaft of the joint portion 110, and may execute, through the motor, a drive command received from the control unit 200, such as speed control, position control, or torque control. The drive unit 180 may stably control movement of the robot arm 120 by including a high-precision reducer therein, and may be designed to maintain mechanical rigidity even against an external impact. Further, the drive unit 180 may internally arrange wirings of sensors such as the encoder 150 and the current sensor 160 to prevent cable twisting or disconnection.

In one embodiment, the control unit 200 may detect an abnormal state of the collaborative robot 100 based on the current data and the rotation data. For example, the control unit 200 may perform core control logic of the collaborative robot 100 and may detect, in real time, an abnormal state based on data collected from the current sensor 160 and the encoder 150. The control unit 200 may be implemented in various forms, such as a microprocessor, an MCU, a DSP, an FPGA, or an industrial PC, and may perform data processing with a fast cycle of 5 ms or less by mounting a real-time operating system (RTOS). The control unit 200 may integrally analyze a current value measured by the current sensor 160 and a rotation angle, a speed, an acceleration, and the like calculated from the encoder 150 to determine states of collision, overload, overspeed, and singularity. Further, the control unit 200 may check temperature data transmitted from the temperature sensor 170 and may control operation of the robot or generate a warning when an overheating state occurs.

When an abnormal state is detected, the control unit 200 may transmit, to each drive unit 180, a command for temporarily stopping operation of the robot or limiting a speed thereof, thereby promoting safety of the collaborative robot 100 and protection of components. For example, when the current sensor 160 detects a current exceeding a threshold value due to a collision, the control unit 200 may immediately transmit, to the drive unit 180 of the corresponding joint portion 110, a Safe Torque Off command to cut off motor torque or switch to a low-speed mode, thereby preventing additional damage. Further, when an overspeed state is detected and it is determined that an actual speed calculated by the encoder 150 is outside an allowable range, the control unit 200 may issue a speed limiting command to the drive unit 180 to control movement of the robot arm 120.

Meanwhile, in order to detect a singularity state, the control unit 200 may calculate a Jacobian matrix based on position data of each joint portion 110 transmitted from the encoder 150. When a minimum singular value of the Jacobian matrix falls below a specific threshold value, this means that the robot arm 120 has entered a singularity section, and thus the control unit 200 may issue a speed deceleration command to the drive unit 180 or may control the robot to detour along a path. Through this, a problem in which the robot is abruptly accelerated or a control error occurs unstably near the singularity may be prevented.

As an example, the plurality of joint portions 110 may be configured as six or seven or more axes to implement a range of motion similar to a human arm, and the base portion 130 may be fixed to a factory floor or a workbench by a bolting method. The robot arm 120 may be manufactured with an aluminum alloy frame, and servo motors and high-precision reducers embedded in the respective joint portions 110 may be coupled to one another, thereby enabling handling of workpieces ranging from a small size to a medium size. The gripper 140 may be exemplified as a two-finger gripper, and a separate sensor may be mounted thereon to transmit, to the control unit 200, whether an object is gripped. At this time, the encoder 150 may optically measure a rotational position of each joint portion 110 with high resolution, and the current sensor 160 may use a Hall sensor to detect a change in motor current with low noise. The temperature sensor 170 may be attached to a motor housing and may be interlocked with the control unit 200 such that, when heat generation becomes severe, a cooling fan is operated.

The collaborative robot 100 configured as described above may monitor various abnormal states, such as an external collision, overload, overspeed, and singularity, at a rapid response speed of 5 ms or less through the real-time collision and overspeed detection system 10, and when such an abnormal state occurs, may immediately switch robot operation to a safe mode or stop the operation, thereby greatly improving safety in an environment in which a human and the robot work together. Further, since respective components are modularized, a length of the robot arm 120 or a form of the gripper 140 may be easily replaced according to user requirements, and specifications of the temperature sensor 170, the current sensor 160, and the like may also be changed according to applications.

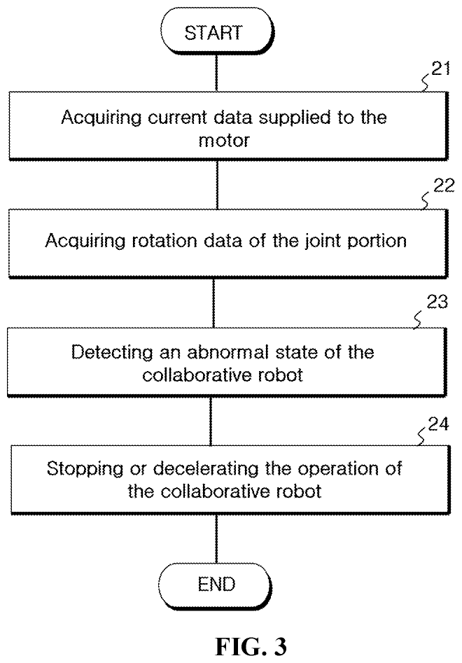

FIG. 3 is a flowchart illustrating a method for real-time collision and overspeed detection of a collaborative robot according to an embodiment of the present disclosure.

Referring to FIG. 3, in an embodiment, in operation 21, the current sensor 160 may acquire current data supplied to the motor. To this end, the current sensor 160 may operate in conjunction with a motor driver circuit to measure, in real time, an instantaneous value, an average value, and a spike-like surge phenomenon of current applied to the motor. The current sensor 160 may use a shunt resistor method, a Hall sensor method, or another precision sensing technique, and may collect data at a short cycle of 5 ms or less, thereby detecting even a minute current change occurring while the collaborative robot 100 is driven. Further, in order to compensate for an error due to an internal temperature of the motor or an ambient environmental condition, the current sensor 160 may apply, when necessary, a compensation coefficient in cooperation with the temperature sensor 170. Through this, the current sensor 160 may distinguish between one-time noise and an actual increase in load, and may quickly identify a sign when a collision state or an overload state occurs. For example, when the motor connected to the joint portion 110 encounters an unexpected resistance and current rapidly increases, the current sensor 160 may detect this change in units of several milliseconds and transmit data necessary for the control unit 200 to respond quickly.

In an embodiment, in operation 22, the encoder 150 may acquire rotation data of the plurality of joint portions 110. For example, the encoder 150 may be implemented as an optical type or a magnetic type, and may precisely measure an angle and a speed at which each joint portion 110 moves and transmit the same to the control unit 200. For instance, the encoder 150 may convert a pulse signal generated whenever the joint portion 110 rotates into a digital value, thereby estimating a current posture and a moving speed of the robot arm 120. Such rotation data of the encoder 150 may play a key role in feedback control for a path of robot motion, and may be essential for accurate positioning of the robot and implementation of a smooth motion. In addition, the encoder 150 may measure an error between a target position or speed set for the motor and an actual motion of the joint portion 110, thereby helping the control unit 200 perform real-time correction (feedback control). For example, when a positional error is accumulated because the joint portion 110 receives an unexpected force, the encoder 150 may immediately detect the same and report the same to the control unit 200, thereby maintaining motion of the robot safely.

In an embodiment, in operation 23, the control unit 200 may detect an abnormal state of the collaborative robot 100. For example, the control unit 200 may integrally analyze current data transmitted from the current sensor 160 and rotation data acquired from the encoder 150, thereby determining abnormal states such as collision, overload, overspeed, and singularity. A collision situation generally exhibits a pattern in which motor current instantaneously surges, and an overload state may be identified as a pattern in which a high current is maintained for a predetermined time or more. Further, the control unit 200 may recognize a situation in which the robot unnecessarily moves quickly by checking, based on a speed calculated by the encoder 150, whether an overspeed threshold value is exceeded. In addition, a singularity state may be defined as a time point at which an angle of the plurality of joint portions 110 satisfies a particular condition and a minimum singular value of a Jacobian matrix becomes significantly low, and, at this time, the control unit 200 may automatically control the robot arm 120 so as not to become unstable in motion. When the abnormal state is identified as described above, the control unit 200 may immediately switch to a safe mode or issue a speed reduction command to control operation of the robot. For example, when current data exceeds a threshold value and a sharp positional error is detected by the encoder 150, the control unit 200 may determine that there is a very high possibility of collision and may immediately cut off motor torque of the joint portion 110.

In an embodiment, in operation 24, the control unit 200 may stop operation of the collaborative robot 100 or decelerate a speed of the collaborative robot 100 to a preset speed or less. For example, this may be a protective measure after the abnormal state is determined in operation 23, so as to immediately control operation of the robot before the abnormal state leads to greater damage or a safety accident. Stopping operation may be implemented in a complete stop (Safe Torque Off) manner, and torque to the motor drive unit 180 may be cut off so that the joint portion 110 no longer moves. On the other hand, when speed limitation is more appropriate than complete stopping in view of a nature of the work, the control unit 200 may reduce the speed of the robot to a preset low-speed range, thereby preventing the abnormal state from seriously spreading. For example, when a minor collision occurs, the robot may be designed to switch to a low-speed mode rather than stopping immediately, so as to reconfirm a surrounding situation. This may provide an effect of minimizing an unnecessary interruption while ensuring safety in an environment in which the collaborative robot 100 should continuously perform work in a production line.

In an embodiment, after confirming that the abnormal state has been resolved, the control unit 200 may perform a process of restoring operation of the robot. Specifically, the control unit 200 may reanalyze data collected from the current sensor 160 and the encoder 150 to determine whether indicators of collision, overload, overspeed, and the like have returned to a normal range. For example, when current temporarily surges due to a collision and is now stabilized so that a current value has returned to the normal range, the control unit 200 may switch the robot back to an original work mode. At this time, the control unit 200 may issue a restore command while the joint portion 110 is completely stopped, or may restart work gradually in a low-speed mode so as to improve safety. Further, by inspecting a load weight or a state of a drive component with respect to the joint portion 110 that has been in the overload state, preventive measures may be taken so that a problem does not repeatedly occur. The control unit 200 may set such a restoring procedure in detail in order to minimize an unnecessary stop time in consideration of efficiency of a work site while ensuring both safety of robot components and safety of a user.

In an embodiment, the control unit 200 may store, in the form of a log, data acquired during robot operation (a current value of the current sensor 160, a rotation angle of the encoder 150, a time point at which an abnormal state occurs, a collision intensity, and the like), and may process the same to be analyzed later or output in the form of a report. The control unit 200 may transmit log data recorded in an internal memory to an external server or a cloud system when necessary, thereby monitoring an operation state of the robot over a long term and using the same to establish a maintenance strategy. For example, when a collision repeatedly occurs at a particular joint portion 110, a drive unit 180 or a motor alignment state of the corresponding joint portion 110, or an arrangement of a work space may be reexamined so as to prepare an improvement plan. Further, when an overload state frequently occurs, it may be checked whether the collaborative robot 100 is actually operating in excess of a load that can be handled, or whether there is a structural problem in the robot arm 120 or wear of a component is in progress. Through this, the control unit 200 may be operated in a direction of identifying a maintenance time point of the robot in advance and minimizing an unexpected downtime in a production line.

The series of procedures from operation 21 to operation 24 described above may be repeatedly performed while the collaborative robot 100 operates, and some operations may be omitted or an order thereof may be changed according to driving conditions of the robot or a work environment. For example, in a simple operation that does not require singularity detection logic, a singularity determination operation among operation 23 may be skipped, and, in a low-speed operation in which an overspeed state does not occur at all, a process of comparing an overspeed threshold value may be omitted. Further, after the control unit 200 detects an abnormal state one or more times and stops the robot, from a restarting time point, a re-initialization process may be performed to reset a reference value of the current sensor 160 or a reference position of the encoder 150, thereby improving measurement accuracy.

Through operations according to the present disclosure as described above, the collaborative robot 100 may check, in real time, current and rotation data supplied throughout the plurality of joint portions 110 and may immediately respond when an abnormal state occurs, thereby implementing a safe work environment. In particular, unlike a conventional scheme depending on an external sensor or a vision system, since motor internal current and joint rotation data are directly analyzed, an abnormal state can be detected with high precision while reducing installation costs and complexity of additional equipment. Further, after the robot is stopped or switched to a low-speed mode, whether the abnormal state has been resolved may continue to be tracked so that the robot may promptly return to the original work mode, thereby minimizing a loss in productivity. Such a series of operations is particularly important in an industrial environment in which the collaborative robot 100 should work with a person at a short distance, and may contribute to simultaneously improving safety and efficiency.

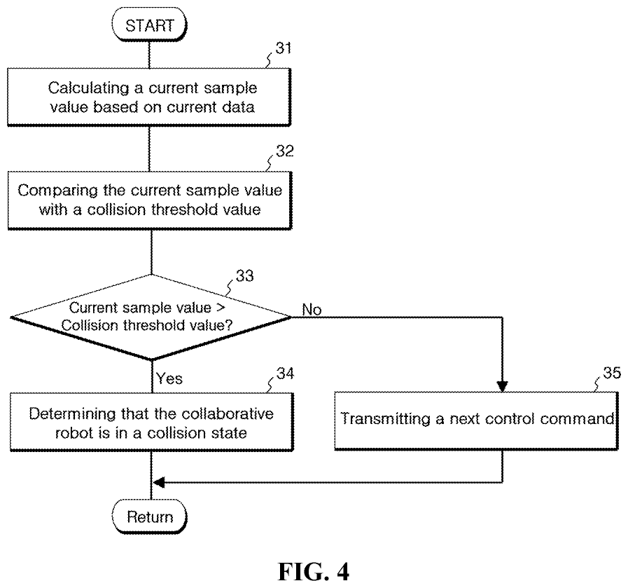

FIG. 4 is a flowchart illustrating a method of determining a collision state of a collaborative robot according to an embodiment of the present disclosure.

Referring to FIG. 4, in an embodiment, in operation 31, the control unit 200 may calculate a current sample value based on current data. For example, the current sample value may refer to a result value obtained by collecting current data supplied to a motor provided in a joint portion 110 of the collaborative robot at a predetermined sampling period and processing the collected current data according to a predetermined algorithm. The control unit 200 may store measurement data transmitted from the current sensor 160 at predetermined time intervals dt, and may prepare basic information for determining whether the robot is normally driven by calculating a difference between an expected current value Iexpj according to motor operation and an actually measured current value Ij. Such a current sample value may instantaneously increase when the robot encounters an unexpected resistance or when a collision occurs during work so that the motor receives a sudden load. Accordingly, the control unit 200 may mathematically process an amount of change in current over a short time interval of H samples to quantify how much force (torque) the motor is actually generating.

For example, the control unit 200 may obtain a current sample value Ck for determining collision according to Equation 1. As shown in Equation 1,

$${C}_{k} = \frac{1}{H} {\sum }_{j = k - H + 1}^{k} \vert {I}_{j} - {I}_{{exp}_{j}} \vert \qquad [ Equation 1 ]$$

wherein k is a natural number, Ij is a current measured at a current time point, Iexpj is an expected current at the current time point, H is the number of sampling intervals, and Ck is the current sample value.

The control unit 200 may define, as the current sample value Ck, an average obtained by summing absolute-value differences between Ij and Iexpj over H samples at a k-th time point and dividing the sum by H. At this time, as an absolute value of Ij-Iexpj becomes higher, this means that an actual current deviates more greatly from an expected current, and thus a possibility that a collision, an overload, or another abnormal state has occurred in the joint portion 110 of the robot may increase.

In an embodiment, in operations 32 and 33, the control unit 200 may compare the current sample value with a collision threshold value. For example, the collision threshold value may be a numerical value indicating an allowable range of current deviation while the robot normally operates, and may vary depending on a work environment and specifications of the robot. For example, when it is assumed that an average amount of current required when a motor mounted in the joint portion 110 of the robot operates at a constant speed is 0.8 A, the collision threshold value may be set to a level slightly higher than that, such as 1.2 A to 1.5 A. However, in an actual implementation, more precise collision detection may be enabled by using not only a simple absolute value but also a subdivided threshold value according to a joint speed, a posture of the robot arm 120, whether an object is gripped, and the like.

The control unit 200 may examine whether the current sample value Ck calculated at the k-th time point exceeds the collision threshold value, and may estimate an abnormal state of the robot through the examination. When Ck is lower than the collision threshold value, this means that the joint portion 110 of the robot is moving with current within a predicted range, and thus there is a high possibility that an additional safety measure is unnecessary. However, when Ck exceeds the collision threshold value, this suggests that the robot is receiving a much greater load than expected, and thus the control unit 200 may determine that the situation may lead to occurrence of a collision. Such a comparison operation may be sequentially performed in operations 32 and 33. For example, in operation 32, it may first be checked whether Ck has reached near the collision threshold value, and, in operation 33, a final collision determination may be made by further checking a finely adjusted criterion or an additional condition, such as a number of samplings or whether continuous occurrence is present.

In an embodiment, in operation 34, when a result of the comparison indicates that the current sample value exceeds the collision threshold value, the control unit 200 may determine that the collaborative robot is in a collision state. Here, the “collision state” may refer to a situation in which the joint portion 110 of the robot actually comes into contact with an external object or a worker and physical resistance sharply increases, and may exhibit characteristics distinguishable from other abnormal states such as overload or overspeed. When the control unit 200 determines that the collaborative robot is in the collision state, the control unit 200 may immediately transmit, to the drive unit 180, a command for limiting or stopping operation of the robot. For example, damage due to collision may be minimized by cutting off torque of the motor or lowering a rotational speed of the joint portion 110 to a safe mode. Further, the control unit 200 may record data of the encoder 150 and a log of the current sensor 160 at a time point at which the collision occurs so as to be used later for analyzing a cause of the collision or preventing recurrence of the collision.

A method in which the control unit 200 determines the collision state by calculating the current sample value according to Equation 1 may have an advantage in that an amount of change in current over a short time is directly reflected. That is, when current values measured by the current sensor 160 in units of milliseconds are grouped into H groups and averaged, an abrupt surge pattern due to an actual collision may be more reliably identified than temporary noise or a one-time spike. Further, in order to distinguish whether a reason for an increase in motor load is an increase in mechanical friction or a collision with an outside of the robot, the control unit 200 may refer to information on a rotational speed or acceleration of the motor. When current rapidly surges although the motor has received a speed-maintaining command, it may be estimated that there is a high possibility of a collision caused by an external resistance, such as an obstacle or a human body.

In an embodiment, in operation 35, when a result of the comparison indicates that the current sample value is equal to or less than the collision threshold value, the control unit 200 may transmit a next control command to the drive unit 180. For example, in this case, it is determined that the collaborative robot is not in the collision state, and thus a normal operation mode may be maintained as it is or a planned work procedure may be continued. For example, when the robot is performing an operation of moving an object, the control unit 200 may transmit a command “move to a next step” to the drive unit 180, and the robot arm 120 may continue to operate along a preset path. Further, when a state in which the current sample value is sufficiently lower than the threshold value continues, the control unit 200 may additionally issue a command for optimizing robot operation for a faster speed or higher efficiency. For example, in a section determined as having “no risk of collision,” an acceleration of the motor may be increased to improve work speed, or a moving path of the robot arm 120 may be modified to be shorter so as to maximize productivity.

Furthermore, in operation 35, the control unit 200 may not rely only on a result indicating that the current sample value is equal to or less than the collision threshold value, and may also simultaneously check other abnormal factors such as an overspeed state, an overload state, and a singularity state. For example, even when the current sample value falls within a normal range, a speed reported by the encoder 150 may exceed the overspeed threshold value, and thus, in this case, the control unit 200 may make an overspeed determination through another algorithm. Accordingly, a “next control command” transmitted to the drive unit 180 in operation 35 does not simply mean a normal operation, and may be a result value in consideration of whether the robot is in another abnormal state, such as overspeed or approaching singularity. This may be for implementing safer and more flexible robot control by integrally analyzing data of the current sensor 160 and the encoder 150 without being limited to a single sensor in the collision detection system presented by the present disclosure.

The order of operations 31, 32, 33, 34, and 35 described in the present embodiment may be repeatedly performed in a real-time operation control process of the collaborative robot 100, and the control unit 200 may skip some operations or insert an additional verification operation according to a situation. For example, when the current sample value Ck is very close to the collision threshold value but does not yet exceed the same, the control unit 200 may temporarily lower the speed of the robot and switch the robot to a preliminary safety mode, and then may check remeasured current data. Through this, a potential collision may be prevented in advance, or a situation in which a size or weight of a workpiece suddenly changes may be handled. Further, by setting the collision threshold value itself to dynamically change according to a posture of the joint portion 110 of the robot or a load weight, a collision detection algorithm more optimized for a specific work situation may be implemented.

As described above, in operation 31, the control unit 200 may calculate the current sample value based on the current data, may predict a possibility of collision of the robot through comparison with the collision threshold value in operations 32 and 33, and, when a result thereof exceeds the threshold value in operation 34, may declare the collision state and perform an appropriate safety measure. On the other hand, when a determination that the current sample value is equal to or less than the threshold value is made in operation 35, the control unit 200 may issue a next operation command to the drive unit 180 so that the robot may continue in a normal operating state. This series of processes is a core of a motor current-based collision detection technique, and may provide an advantage in that whether a collision has occurred is determined only through an internal sensor of the robot without using a conventional external sensor or a complicated image analysis system. As a result, it is possible to reduce installation costs and a maintenance burden of the robot system while shortening a response speed and improving collaborative safety of a worker and the robot.

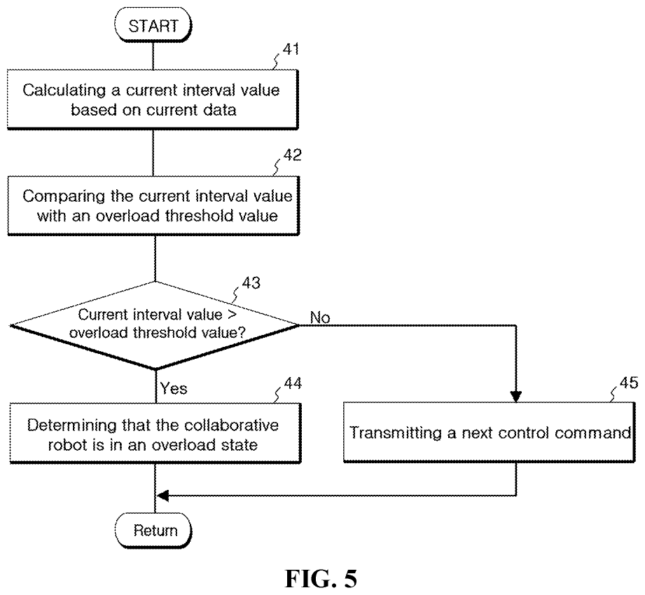

FIG. 5 is a flowchart illustrating a method of determining an overload state of a collaborative robot according to an embodiment of the present disclosure.

Referring to FIG. 5, in an embodiment, in operation 41, the control unit 200 may calculate a current interval value based on current data. For example, at this time, the control unit 200 may calculate an indicator capable of diagnosing an overload state by measuring current supplied to a motor at predetermined intervals and analyzing accumulated current. Specifically, by collecting current values Ij at respective time points transmitted from the current sensor 160 in units of L samples, the control unit 200 may evaluate how much current the robot maintains during a predetermined period of time. Such a current interval value Ok may be calculated according to Equation 2 below, and, in Equation 2, L may indicate a preset length of a measurement interval.

$${O}_{k} = \frac{1}{L} {\sum }_{j = k - L + 1}^{k} {I}_{j} \qquad [ Equation 2 ]$$

wherein k is a natural number, Ij is a current measured at a current time point, L is a preset measurement interval, and Ok is the current interval value.

The control unit 200 may determine an average by summing previous L current values at a k-th time point, thereby identifying a current level over a predetermined time interval rather than merely an instantaneous current spike. This takes into account that an overload state is generally not a brief surge, but rather a phenomenon in which a high current is maintained over a predetermined period. For example, when the collaborative robot 100 grips a heavy object for a long time or an unexpectedly high resistance continues to act on the joint portion 110, current values measured by the current sensor 160 may remain high for a predetermined time or longer.

In an embodiment, in operations 42 and 43, the control unit 200 may compare the current interval value with an overload threshold value. For example, the overload threshold value is a limit value set so that the robot does not exceed a current range within which the robot can safely operate, and may vary depending on a kinematic structure of the robot, a motor rating, cooling performance, and the like. For example, when L is 20 samples, Ok obtained by averaging current values over about 100 ms, assuming a sampling period of 5 ms, may be compared with the overload threshold value. When Ok is much lower than the overload threshold value, the robot may be regarded as operating within a normal load range. Conversely, when Ok exceeds the overload threshold value, it may be determined that the joint portion 110 of the robot is receiving a load beyond a design range.

In operation 42, the control unit 200 may primarily determine whether Ok approaches the overload threshold value, and, in operation 43, may comprehensively review additional conditions, such as a number of samplings and whether continuous occurrence is present within a specific interval, thereby finally determining whether an overload exists. This may be for preventing false detection, so that an instantaneous current increase during robot operation is not erroneously recognized as an overload. For example, the system may be designed such that only when Ok is measured near the overload threshold value several times continuously is an “actual overload state” determined. Further, the control unit 200 may additionally utilize temperature information of a motor or the drive unit 180 measured by the temperature sensor 170, and may analyze whether a thermal burden increases when a high-current state continues for a long time.

In an embodiment, in operation 44, when a result of the comparison indicates that the current interval value exceeds the overload threshold value, the control unit 200 may determine that the collaborative robot is in an overload state. The overload state may mean that the robot is receiving a load beyond a normal operating range, such that a motor, a reducer, a bearing, and the like are under excessive stress. When the overload state continues for a long time, wear of robot components, overheating, energy loss, and the like may occur, thereby reducing work efficiency and stability. Accordingly, as soon as the control unit 200 determines the overload state, the control unit 200 may issue a command for limiting an output of the motor or changing a moving path of the robot arm 120 to reduce the load. For example, when it is estimated that an object being lifted by the joint portion 110 is heavier than expected, the control unit 200 may issue a speed reduction command to distribute the load or may instruct that a work process be stopped so that a work environment is rechecked.

The overload state may be distinguished from a collision or an overspeed state in that “a high current is maintained for a long time.” A collision is mainly identified by an instantaneous surge, and an overspeed state is identified by checking whether a speed measured by the encoder 150 exceeds a threshold value. In contrast, the overload state may be determined in real time as to whether the robot exceeds a work load by using the indicator based on Equation 2, namely, that “an average current of L samples exceeds the overload threshold value.” The control unit 200 may detect in advance a risk that may occur in an operation in which the joint portion 110 lifts a weight greater than or equal to a predetermined weight for a long time, and may take a safety measure before fatal damage occurs to the motor or the drive unit 180.

In an embodiment, in operation 45, when a result of the comparison indicates that the current interval value is equal to or less than the overload threshold value, the control unit 200 may transmit a next control command to the drive unit 180. For example, this means that the robot is receiving a load within a normal range, and thus the control unit 200 may allow a current work state to be maintained or may allow an operation of the robot arm 120 to proceed to a next step. For example, when the robot is performing an operation of moving an object, if Ok is equal to or less than the overload threshold value, it may be determined that the robot can lift the object without excessive strain, and the control unit 200 may instruct the robot to move to a next position according to path planning. Further, when it is confirmed that the robot is not in the overload state, the control unit 200 may issue a command for slightly increasing a motor output or a moving speed for efficient productivity. This may be a way of maximizing work efficiency while maintaining a safe range.

Additionally, operation 45 may include a procedure for returning the robot to an original work mode after an overload state has been resolved for a long time. For example, when the joint portion 110, which was previously temporarily stopped or decelerated because of the overload state, now has the current interval value Ok falling below the threshold value, the control unit 200 may gradually accelerate the operation of the robot and restore the robot to a normal level. At this time, the control unit 200 may also check temperature information of the motor transmitted from the temperature sensor 170, and may delay restoration of a speed if an overheating state has not yet been resolved. Through this, durability of robot components may be ensured and unnecessary failures may be prevented.

The flow from operation 41 to operation 45 described in the present embodiment may be repeatedly performed while the collaborative robot 100 is actually operating, and may rapidly determine the overload state by comprehensively analyzing data obtained from various sensors, such as the current sensor 160, the temperature sensor 170, and the encoder 150. In particular, by using the current interval value Ok defined in Equation 2, it is possible to clearly distinguish whether the robot instantaneously consumes a high current at a specific point in time or whether the robot continuously requires a high current during a predetermined period. Unlike instantaneous collision detection, this may be a method of more effectively determining a situation in which a long-term load increase occurs.

For example, when L is set to 50 and a sampling period is assumed to be 2 ms, Ok is calculated by averaging current values over about 100 ms. When, while the robot lifts an object, the weight of the object unexpectedly increases or an additional friction occurs in the joint portion 110 so that the motor continuously consumes a high current, Ok may gradually exceed the overload threshold value. Upon detecting this, the control unit 200 may immediately limit operation of the joint portion 110 in order to prevent long-term damage to the motor, or may stop the operation and display a warning message so that a user inspects the robot. Conversely, when Ok is stably maintained at or below the threshold value, the robot may continue the work within a normal range without overload, thereby enabling a user to secure both high productivity and safety.

Further, the control unit 200 may accumulate log data as to whether the overload state occurs frequently and may determine whether a specific joint portion 110 frequently causes a problem or whether a load is excessively applied at a specific work step. Through this, a user may secure long-term stability by redesigning path planning of the robot arm 120 or adjusting specifications of the drive unit 180 upward. Further, an overload threshold value may be dynamically adjusted so that the threshold value flexibly changes depending on a kind of work or a state of robot components. For example, when a motor temperature is already high because the robot continuously operates for a long time, the threshold value may be lowered to prevent damage to the components.

In conclusion, the process in which the control unit 200 calculates the current interval value in operation 41, compares the current interval value with the overload threshold value in operations 42 and 43, determines the overload state in operation 44 and then takes a necessary safety measure, or confirms in operation 45 that the current interval value is at or below the threshold value and proceeds with a normal operation, may play a key role in real-time overload detection and response of the collaborative robot 100. Through this series of procedures, the robot may efficiently monitor not only a collision or an overspeed state but also a gradually accumulated load increase, thereby ensuring both safety of a worker and durability of equipment.

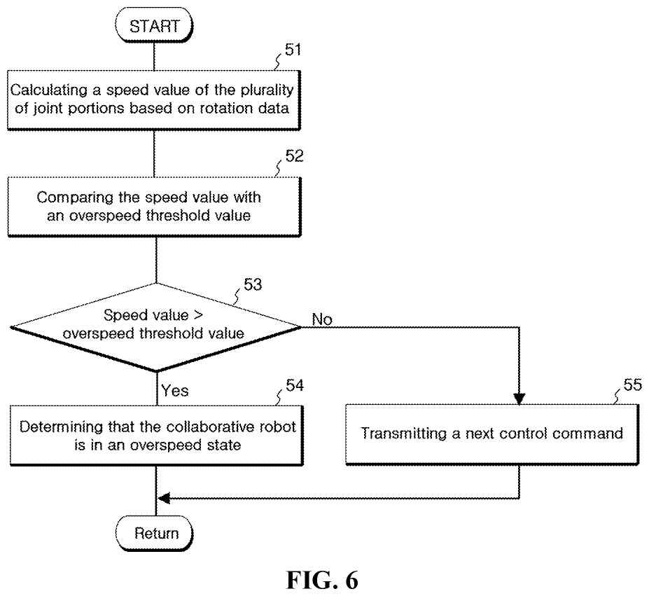

FIG. 6 is a flowchart illustrating a method of determining an overspeed state of a collaborative robot according to an embodiment of the present disclosure.

Referring to FIG. 6, in an embodiment, in operation 51, the control unit 200 may calculate speed values of the plurality of joint portions based on rotation data. For example, the rotation data may indicate an angular variation or a pulse count of the joint portion 110 acquired from the encoder 150, and the control unit 200 may calculate a joint speed by dividing the same by a time interval. For example, when the encoder 150 measures and transmits an angle at predetermined intervals, the control unit 200 may calculate a rotational speed of the joint portion from the angular variation. In addition, the control unit 200 may further calculate an acceleration or a positional error of the joint portion, thereby precisely determining an actual movement of the robot arm 120. Such joint speed information may serve as important grounds for determining whether the collaborative robot 100 departs from a target speed range or operates faster than expected. For example, whether a risk of overspeed increases because the acceleration sharply rises only at a particular operation step of the robot may also be identified through this joint-speed calculation process.

In an embodiment, in operations 52 and 53, the control unit 200 may compare the speed values with an overspeed threshold value. For example, the overspeed threshold value may be a value defining a maximum speed at which the collaborative robot 100 can safely move, and may be set in consideration of a structure of the robot, motor performance, a work environment, and the like. For example, when it is determined that a speed exceeding 300°/s for each joint may pose a risk to a nearby worker or facility, such speed may be set as the overspeed threshold value. In operation 52, the control unit 200 may primarily determine whether a current speed value approaches the overspeed threshold value, and, in operation 53, may additionally examine conditions such as whether the speed is measured continuously several times or more near the threshold value and whether an angular range of the joint portion 110 corresponds to a singular point, thereby finally determining the overspeed state. Through this, the control unit 200 may implement logic for recognizing an actual overspeed state only when a speed above a predetermined level continues, without unnecessarily determining an overspeed state because of a single instantaneous speed peak.

In an embodiment, in operation 54, when a result of the comparison indicates that the speed value exceeds the overspeed threshold value, the control unit 200 may determine that the collaborative robot is in an overspeed state. For example, the overspeed state may refer to a state in which the joint portion 110 of the collaborative robot 100 exceeds a maximum speed defined by safety guidelines, thereby increasing a risk of collision with a surrounding environment or a work target and likely causing mechanical damage to robot components. As soon as detecting the overspeed state, the control unit 200 may issue a speed-limit command to the drive unit 180 to suppress a movement of the robot or may switch the robot into a low-speed mode, thereby ensuring work safety. For example, while the robot is moving at a somewhat high speed for smooth work, when the control unit 200 determines that such movement is dangerous in consideration of a distance to a nearby worker or a load state, the control unit 200 may immediately reduce a driving speed of the joint portion 110 so that human-body safety standards are satisfied. In addition, the control unit 200 may store a log of the encoder 150 at a time point when the overspeed state occurs and may utilize the same for improving a work-process design or adjusting robot speed-control parameters through later analysis.

The overspeed state may be determined merely by instantaneously recording a speed exceeding a preset threshold value. However, for efficient robot operation, it may also be considered whether a speed above a predetermined reference continues for a predetermined period of time. For example, when a peak exceeding the threshold value occurs only for about 1 to 2 ms, the control unit 200 may process the same as noise or instantaneous acceleration rather than regarding the same as overspeed. In contrast, when the overspeed threshold value is exceeded continuously for several tens of milliseconds or more, it may be desirable to determine that a clearly dangerous state exists and control the operation of the robot. Such an overspeed-determination logic may operate integrally with collision and overload determination logic, thereby enhancing the overall safety of the robot.

In an embodiment, in operation 55, when a result of the comparison indicates that the speed value is equal to or less than the overspeed threshold value, the control unit 200 may transmit a next control command to the drive unit 180. For example, when it is determined that the joint portion 110 of the robot operates within a target speed range, the control unit 200 may continue the operation and, if necessary, may instruct a higher speed or an optimized path. For example, when a work situation is determined to be safe, a strategy of slightly increasing a moving speed of the robot arm 120 may be employed to improve productivity. In addition, although the robot has limited its speed in a specific section, when it is now determined that the speed is maintained at or below the threshold value, the control unit 200 may restore the robot to an originally planned speed so as to maximize work efficiency. This may contribute to balancing safety and productivity by allowing the collaborative robot 100 not merely to remain in a safety mode but to flexibly perform speed control in an actual work site.

Meanwhile, in operation 55, the control unit 200 may monitor whether the robot maintains a speed within a safe range for a predetermined period of time or more by checking, over a plurality of sampling periods, that no overspeed determination is made. Through this, the control unit 200 may transmit a signal indicating that the robot is “safely operating” to another upper-level system, such as a process-management server, or may instruct the robot arm 120 to change a path and move to a next process. In addition, by integrally analyzing the data of the encoder 150 and the data of the current sensor 160, the control unit 200 may examine whether a current variation also remains within a low range while the speed is stably maintained. When a speed is at an appropriate level but a high current is measured, a possibility that another abnormal state, such as overload, has occurred cannot be excluded, and thus the overload state may be reexamined using a separate algorithm.

As described above, the series of processes in which the control unit 200 calculates the speed values of the joint portion 110 through the encoder 150 in operation 51, compares the same with the overspeed threshold value in operations 52 and 53, immediately takes a safety measure such as speed limitation when determining an overspeed state in operation 54, and continues a normal operation when the speed value is equal to or less than the overspeed threshold value in operation 55 may be a very important safety-control procedure in an environment where a robot works in collaboration with a human. In particular, when the robot moves with high inertia or acceleration, a risk of colliding with a worker may increase, and thus promptly determining and responding to the overspeed state plays a key role in safe operation of the collaborative robot 100. Further, such an overspeed-determination logic may be linked with whether a singular point is approached or whether a collision occurs, thereby constructing an overall robot-operation safety system.

For example, when the joint portion 110 approaches a singular point in a particular posture so that the possibility of a sudden change in speed increases, the control unit 200 may recognize such fact in advance and may more conservatively set a safety limit by further lowering the overspeed threshold value. In contrast, in the case of a robot operating automatically in an enclosed space in which no worker is present, even when the overspeed threshold value is set somewhat higher, no substantial problem may arise. Thus, the control unit 200 may dynamically change the overspeed threshold value according to a work environment and a state of the robot, and the processes from operation 51 to operation 55 may evaluate the robot speed using the threshold value changed at each time, thereby implementing robot-operation control satisfying both safety and efficiency.

Additionally, the control unit 200 may identify, through log data, whether there is a joint portion 110 or an operation step in which an overspeed determination frequently occurs. Based thereon, a path design of the robot arm 120 may be reexamined or a speed profile may be reset, thereby reducing a frequency of overspeed determination and optimizing a work flow. Further, when the robot frequently receives an overspeed determination, it may be necessary to examine whether a weight of a workpiece mounted on the gripper 140 fluctuates or whether rotational characteristics have changed because the drive unit 180 of the joint portion 110 is worn. The control unit 200 may predict a maintenance time point or establish a component-replacement plan through such feedback information, thereby contributing to increasing an equipment operation rate and preventing unexpected downtime.

As a result, the cyclic process of operations 51, 52, 53, 54, and 55 proposed in the present disclosure may specifically represent an overspeed-detection and control procedure essential for safe operation of the collaborative robot 100. By periodically checking the speed values of the joint portion calculated through the encoder 150 and determining whether the same exceed the overspeed threshold value, dangerous high-speed operation may be prevented in advance even in a work space where a human and a robot are close to each other. In addition, when it is determined that the speed is maintained within a normal range, the control unit 200 may transmit an additional command to the drive unit 180 for maximizing work efficiency. In this way, the present disclosure presents an overspeed-control scheme considering both safety and productivity, thereby allowing operation of the collaborative robot to be performed more effectively.

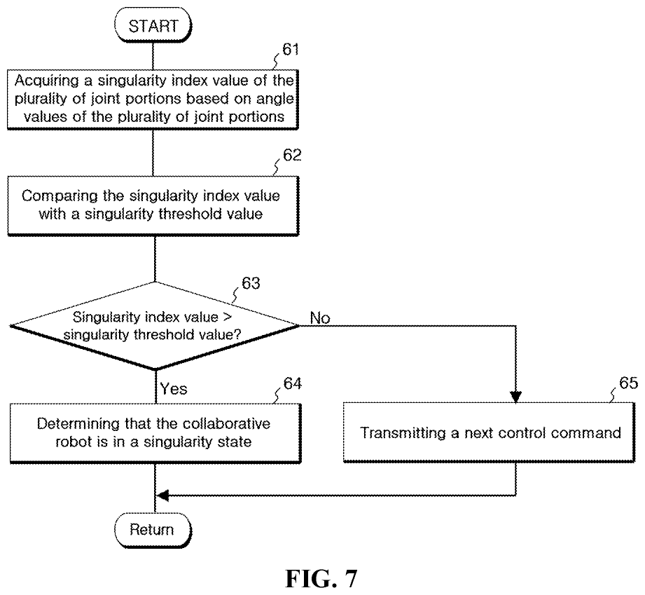

FIG. 7 is a flowchart illustrating a method of determining a singularity state of the collaborative robot according to an embodiment of the present disclosure.

Referring to FIG. 7, in one embodiment, in operation 61, the control unit 200 may acquire a singularity index value of the plurality of joint portions based on angle values of the plurality of joint portions included in the rotation data. For this purpose, the control unit 200 may first collect real-time information on each axis angle of the joint portions 110 from the encoder 150, and may calculate a Jacobian matrix based on the collected angle values. The Jacobian matrix is a key element representing kinematic characteristics of a robot manipulator, and may mathematically represent how a minute change in the joint portions 110 affects the position and posture of an end of the robot arm 120. The control unit 200 may calculate the Jacobian matrix according to a robot joint structure such as a link length and a rotational axis configuration, and may extract a minimum singular value SMink by performing singular value decomposition, SVD, or a similar algorithm on the Jacobian matrix. In this case, as the minimum singular value becomes smaller, it may indicate that the robot joint is closer to a singular point.

For example, the control unit 200 may analyze the angle values, calculate the Jacobian matrix at a current point in time, extract a minimum singular value from values of the Jacobian matrix, and calculate the singularity index value according to Equation 3 below.

$$Mk = \frac{1}{{SMin}_{k}} \qquad [ Equation 3 ]$$

wherein Mk is a singularity index value, and Smink is a minimum singular value.

As SMink approaches 0, this may mean that the joint portions 110 of the robot are taking a posture very similar to a singularity state, and its reciprocal, Mk, becomes larger. That is, as Mk becomes larger, it may be intuitively understood numerically that the robot is near a singular point. The control unit 200 may perform such a calculation process in operation 61, and may calculate an Mk value reflecting the angle data of the joint portions 110 at each point in time.

In one embodiment, in operations 62 and 63, the control unit 200 may compare the singularity index value with a singularity threshold value. For example, the singularity threshold value is a reference value set to maintain a safe operating range of the robot, and when Mk exceeds the singularity threshold value, it may be determined that there is a high possibility that the robot will cause excessive acceleration or unstable operation near a singular point. For example, it may be set that sensitivity of robot control increases significantly from a point where Mk exceeds 10, and in this case, there may be an increased risk that an end portion will move abruptly or a control error will be amplified even by a minute movement of the joint portions 110. In operation 62, the control unit 200 may primarily compare Mk with the singularity threshold value to determine whether Mk approaches the threshold value, and in operation 63, may make a final determination of a singularity state by reflecting additional conditions such as whether Mk continuously exceeds the threshold value over multiple samples and whether a particular joint portion 110 corresponds to a particular angle range.

In one embodiment, in operation 64, when the singularity index value exceeds the singularity threshold value, the control unit 200 may determine that the collaborative robot is in a singularity state. For example, the singularity state may refer to a state in which the joint portions 110 form a particular angular arrangement in a serialized section, causing rank deficiency of the Jacobian matrix or causing the minimum singular value to approach 0. In this state, robot control may become unstable or speed may change abruptly, and there may be a high possibility that an unpredictable movement will occur. Accordingly, when determining that the robot is in the singularity state, the control unit 200 may immediately transmit a control command to the drive unit 180 to decelerate an operation of the joint portions 110 or to change a path. For example, when detecting that the robot arm 120 is entering a region near a singular point, the control unit 200 may slightly detour a movement path of the robot so as to avoid the singular point, or may switch an operation of the joint portions 110 to a low-speed mode so that the robot safely passes therethrough.

When the robot moves quickly in the singularity state, a control error may be amplified very greatly, and there may be an increased risk that the collaborative robot 100 unexpectedly moves in an unintended direction and collides with surrounding equipment or a human body. Accordingly, the control unit 200 may immediately detect a moment when Mk exceeds the threshold value, and may prevent an accident in advance by adjusting an operation of the robot. Unlike other abnormal states such as collision, overload, and overspeed, this may serve as an important safety device for resolving a control difficulty caused by an internal kinematic structure of the robot.

In one embodiment, in operation 65, the control unit 200 may perform follow-up control. For example, when the robot has been switched to the low-speed mode or has been caused to detour the path after the singularity state is detected, the control unit 200 may continuously monitor whether the singularity index value Mk again falls to or below the singularity threshold value. When Mk is maintained at a sufficiently low value, the control unit 200 may control the robot arm 120 to return to an original speed or path. Further, the control unit 200 may analyze data of the encoder 150 and the current sensor 160 at a point in time when the singularity state is resolved, and may record a load or a speed change applied to the joint portions 110 while the robot passes through a singularity section. Through this, in a similar operation in the future, an operation near the singularity may be further optimized, or an automatic path-planning algorithm upon approach to the singularity may be improved.

Meanwhile, in operation 65, a specific scenario may be determined as to how the overall robot system manages and releases the singularity state. For example, when the robot is performing a welding operation, quality may deteriorate because a welding trajectory shakes in the singularity state, and thus a process may be performed in which the operation is temporarily interrupted, the singularity is detoured, and then the welding is resumed. In contrast, in the case of a simple transport operation, the control unit 200 may maintain work efficiency by allowing the robot to pass through a corresponding section in the low-speed mode and then restoring the original speed when the robot enters a safe section. In addition, the control unit 200 may repeatedly perform such procedures and accumulate a log of robot operations in the singularity state, thereby using the same for subsequent system maintenance or improvement of a work process.

Through the series of operations 61, 62, 63, 64, and 65, the present disclosure may calculate a singularity index Mk reflecting kinematic characteristics of the robot manipulator, and may control the collaborative robot 100 to operate safely by determining in real time whether the singularity index exceeds the singularity threshold value. Unlike an external collision or overload, the singularity state is an unstable region created by an arrangement of the joints of the robot itself, and thus if the control unit 200 fails to detect the same quickly, predictability of robot operation may be significantly reduced. However, in the present disclosure, the control unit 200 may quickly identify a point in time of approach to the singularity by measuring joint angles through the encoder 150, obtaining the minimum singular value SMink of the Jacobian matrix, calculating Mk, and determining whether Mk exceeds a particular threshold value.

Further, the present disclosure may additionally use, in addition to the singularity index Mk, another index reflecting an actual movement of the joint portions 110 of the robot, such as a condition number or a determinant value. However, a method using Mk may have an advantage in that, as the minimum singular value of the Jacobian approaches 0, an increase in difficulty of robot control may be simplified and may be easily interpreted numerically. For example, when Mk becomes 20 or greater, it may be considered that the robot arm 120 has entered a considerably unstable section, and from this point the control unit 200 may take various safety measures such as path detouring, speed limitation, and operation interruption.

Ultimately, through an entire process in which the control unit 200 calculates the singularity index Mk based on the angle values in operation 61, compares the same with the singularity threshold value in operations 62 and 63, determines in operation 64 that the robot is in the singularity state, and then performs follow-up control in operation 65, the collaborative robot 100 may detect and prevent unstable motion near the singularity in advance. This may act as a safety factor that is essential to be considered in robot operation together with other abnormal states such as collision, overload, and overspeed. Accordingly, by including a singularity detection function, the present disclosure may simultaneously achieve a high level of safety and work efficiency even in an environment in which a human and a robot collaborate in the same space.

Meanwhile, the disclosed embodiments may be implemented in the form of a recording medium storing instructions executable by a computer. The instructions may be stored in the form of program code, and when executed by a processor, may generate program modules to perform operations of the disclosed embodiments. The recording medium may be implemented as a computer-readable recording medium.

The computer-readable recording medium may include all types of recording media storing instructions that may be read by a computer. For example, the computer-readable recording medium may include ROM (Read Only Memory), RAM (Random Access Memory), a magnetic tape, a magnetic disk, a flash memory, and an optical data storage device.

The disclosed embodiments have been described above with reference to the accompanying drawings. A person having ordinary skill in the art to which the present disclosure pertains will understand that the present disclosure may be practiced in forms different from the disclosed embodiments without changing the technical spirit or essential features of the present disclosure. The disclosed embodiments are illustrative and should not be construed as limiting.

### REFERENCE SIGNS LIST

10 real-time collision and overspeed detection system for a collaborative robot
100 collaborative robot
110 joint portion
120 robot arm
130 base portion
140 gripper
150 encoder
160 current sensor
170 temperature sensor
180 drive unit
200 control unit

What is claimed is:

1. A real-time collision and overspeed detection system for a collaborative robot, comprising:
a collaborative robot including a plurality of joint portions, each of the plurality of joint portions being provided with a motor;
a current sensor configured to acquire current data supplied to the motor;
an encoder configured to acquire rotation data of the plurality of joint portions; and
a control unit configured to detect an abnormal state of the collaborative robot based on the current data and the rotation data.

2. The system of claim 1, wherein the control unit is configured to calculate a current sample value based on the current data, compare the current sample value with a collision threshold value, and determine that the collaborative robot is in a collision state when the current sample value exceeds the collision threshold value.

3. The system of claim 2, wherein the control unit is configured to calculate the current sample value for determining collision according to Equation 1,
$${C}_{k} = \frac{1}{H} {\sum }_{j = k - H + 1}^{k} \vert {I}_{j} - {I}_{{exp}_{j}} \vert \qquad [ Equation 1 ]$$
wherein k is a natural number, Ij is a current measured at a current time point, Iexpj is an expected current at the current time point, H is the number of sampling intervals, and Ck is the current sample value.

4. The system of claim 3, wherein the control unit is configured to calculate a current interval value based on the current data, compare the current interval value with an overload threshold value, and determine that the collaborative robot is in an overload state when the current interval value exceeds the overload threshold value.

5. The system of claim 4, wherein the control unit is configured to calculate the current interval value according to Equation 2,
$${O}_{k} = \frac{1}{L} {\sum }_{j = k - L + 1}^{k} {I}_{j} \qquad [ Equation 2 ]$$
wherein k is a natural number, Ij is a current measured at a current time point, L is a preset measurement interval, and Ok is the current interval value.

6. The system of claim 5, wherein the control unit is configured to calculate a speed value of the plurality of joint portions based on the rotation data, compare the speed value with an overspeed threshold value, and determine that the collaborative robot is in an overspeed state when the speed value exceeds the overspeed threshold value.

7. The system of claim 6, wherein the control unit is configured to acquire a singularity index value of the plurality of joint portions based on an angle value of the plurality of joint portions included in the rotation data, compare the singularity index value with a singularity threshold value, and determine that the collaborative robot is in a singularity state when the singularity index value exceeds the singularity threshold value.

8. The system of claim 7, wherein the control unit is configured to analyze the angle value, calculate a Jacobian matrix at a current time point, extract a minimum singular value from the Jacobian matrix, and calculate the singularity index value according to Equation 3,
$$Mk = \frac{1}{{SMin}_{k}} \qquad [ Equation 3 ]$$
wherein Mk is the singularity index value, and Smink is the minimum singular value.

9. The system of claim 8, wherein the control unit is configured to stop operation of the collaborative robot when an abnormal state of the collaborative robot is detected.

10. The system of claim 9, wherein the control unit is configured to decelerate a speed of the collaborative robot to a preset speed or less when an abnormal state of the collaborative robot is detected.
